(19) United States
(12) Patent Application Publication
(10) Pub. No.: US 2026/0319860 A1
(43) Pub. Date: Oct. 15, 2026

(54) RESOURCE TRANSFER TO GROUP OF RECIPIENTS ACCORDING TO RECIPIENT RESOURCE TRANSFER PREFERENCES

(71) Applicant: THE HUNTINGTON NATIONAL BANK, Columbus, OH (US)

(72) Inventors: Philip A. Van Vlack, IV, Columbus, OH (US); Suhas Gosavi, Columbus, OH (US)

(21) Appl. No.: 19/178,988

(22) Filed: Apr. 15, 2025

(51) Int. Cl. G06F 9/50

(52) U.S. Cl. CPC G06F 9/5072; G06F 9/5027; G06F 2209/5013

(57) ABSTRACT

A system for facilitating resource transfer to a group of recipients according to individual recipient-selected mode of transfer preferences is disclosed. A sender may create a recipient group or may cause a resource transfer computing system to create a recipient group comprising multiple individual recipients to which the sender can simultaneously transfer a resource. A resource transfer computing system can receive a resource transfer command message from a sender computing device, which can include information that at least identifies a resource type, a value of the resource, and the recipient group, and causes the resource transfer computing system to retrieve a set of stored resource transfer rules that are associated with the recipient group and are usable to govern a resource transfer to the group. The resource transfer rules may comprise one or more recipient-selected modes of resource transfer for each recipient in the group of recipients.

### TECHNICAL FIELD

The present disclosure relates generally to user interaction with computing infrastructure, and more particularly, although not exclusively, to facilitating a resource transfer to a group of recipients using individual recipient-selected modes of resource transfer.

### BACKGROUND

Resources may be transferred between parties for various reasons, such as for example, to procure items, or as an exchange of one resource for another. Resource transfers from a sender to a recipient typically occur through an intermediary transferor. It is commonly required, particularly when a given recipient does not regularly receive resource transfers from the sender, that the intermediary transferor must contact the recipient at each request to transfer a resource to the recipient in order to obtain the recipient's preferred mode of resource transfer. This reduces process efficiency and can consume significant computing and human resources. When a resource is to be simultaneously transferred to a group of recipients, the task of obtaining the preferred mode of resource transfer information may be even more arduous, as each individual recipient in the group needs to be contacted. Further, such a group transfer may require that preferred mode of resource transfer information is received from each recipient in the group before the resource can be transferred, which can cause an undesirable delay in transferring the resource to the group.

### SUMMARY

According to one example, a system may include a processor and a memory communicatively coupled to the processor. The memory can include instructions that are executable by the processor to cause the processor to perform operations. The operations may include receiving a resource transfer command message from a sender computing device, wherein the resource transfer command message is associated with a transfer of a resource to a group of recipients and includes resource transfer information that at least identifies a type of the resource, a value of the resource, and the group of recipients. The operations may also include, based on instructions included in the resource transfer command message, retrieving a stored set of resource transfer rules associated with the group of recipients, wherein the set of resource transfer rules includes one or more recipient-selected modes of resource transfer for each recipient in the group of recipients, and configuring a resource transfer module of the system to initiate a transfer of the resource to each recipient in the group of recipients according to the set of resource transfer rules and the resource transfer information in the resource transfer command message.

According to another example, a computer-implemented method may include receiving a resource transfer command message generated by a sender computing device, wherein the resource transfer command message is associated with a transfer of a resource to a group of recipients and includes resource transfer information that at least identifies a type of the resource, a value of the resource, and the group of recipients. The computer-implemented method may also include, based on instructions included in the resource transfer command message, retrieving a stored set of resource transfer rules associated with the group of recipients, wherein the set of resource transfer rules includes one or more recipient-selected modes of resource transfer for each recipient in the group of recipients. The computer-implemented method may additionally include, based on the instructions included in the resource transfer command message, configuring a resource transfer module of a resource transfer computing system to initiate a transfer of the resource to each recipient in the group of recipients according to the set of resource transfer rules and the resource transfer information in the resource transfer command message, and initiating the transfer of the resource.

According to a further example, a non-transitory computer-readable medium may include instructions that are executable by a processor for causing the processor to perform operations. The operations may include receiving a resource transfer command message from a sender computing device, wherein the resource transfer command message is associated with a transfer of a resource to a group of recipients and includes resource transfer information that at least identifies a type of the resource, a value of the resource, and the group of recipients. The operations may also include, based on instructions included in the resource transfer command message, retrieving a stored set of resource transfer rules associated with the group of recipients, wherein the set of resource transfer rules includes one or more recipient-selected modes of resource transfer for each recipient in the group of recipients, and configuring a resource transfer module of the system to initiate a transfer of the resource to each recipient in the group of recipients according to the set of resource transfer rules and the resource transfer information in the resource transfer command message

### BRIEF DESCRIPTION OF THE DRAWINGS

FIG. 1 is a block diagram illustrating a system for facilitating a resource transfer to a group of recipients, according to one example.

FIG. 2 is a block diagram illustrating a first trained machine learning model that may be a part of or may be accessible by the system of FIG. 1.

FIG. 3 is a block diagram illustrating a second trained machine learning model that may be a part of or may be accessible by the system of FIG. 1.

FIG. 4 is a block diagram illustrating various computing components of the system of FIG. 1, according to one example.

FIG. 5 is a schematic representation of a customizable first user interface of a sender computing device via which a sender can specify a resource to be transferred to a group of recipients, according to one example.

FIG. 6 is a schematic representation of a customizable second user interface of the sender computing device of FIG. 5 via which a sender can select one or more additional recipients to include in the group of recipients, according to one example.

FIG. 7 is a schematic representation of a customizable first user interface of a recipient computing device via which a recipient of a group of recipients can select a preferred primary mode of transfer by which to receive future transfers of one or more resource types, according to one example.

FIG. 8 is a schematic representation of a customizable second user interface of a recipient computing device via which a recipient in a group of recipients can select a preferred backup mode of transfer by which to receive future transfers of one or more resource types, according to one example.

FIG. 9 is a schematic representation of a resource transfer notification message displayed on a computing device of a recipient in a group of recipients, according to one example.

FIG. 10 is a flowchart of a computer-implemented method for facilitating resource transfer to a group of recipients utilizing individual recipient-selected mode of transfer preferences, according to one example.

### DETAILED DESCRIPTION

Certain aspects and features of the present disclosure relate to a system for facilitating a resource transfer to a group of recipients (also referred to herein as a “recipient group”) according to modes of resource transfer preselected by the individual recipients within the group. Thus, at least some of the recipients within the group may receive a resource transfer via different modes of resource transfer. It is also possible in some examples that the value of the resource transferred to the recipient group may vary from recipient-to-recipient—i.e., the transferred resource value may be nonuniform across the recipients in the group.

The system may also be operative to effectuate transfer of a resource to the recipients of the recipient group via a secondary (backup) mode of transfer in a case where the resource cannot be transferred using a selected primary mode of transfer. The type of a resource to be transferred by a system and method according to examples of the disclosure can vary. For example, the resource may be a computing resource, including a processing resource (e.g., physical or virtual servers, applications) or a memory resource (e.g., disk storage) such as may be associated with a cloud computing environment. In another example, a resource may be a monetary resource such as a currency payment, a negotiable instrument, a dividend, or another type of transaction resource.

A sender computing device can be initially connected to a remote resource transfer computing system through which the resource is to be transferred. In some examples, the sender computing device can be, for example, a personal computer, a laptop computer, a tablet, a smart phone, etc. In one example, the sender computing device may be communicatively coupled to the remote resource transfer computing system through the Internet. In one particular example, the resource transfer computing system may be a financial services computing system and the resource may be a monetary sum of a given value. For example, the resource may be a payment, a rebate, a refund, or a reward payable by a business or another entity to a group of payees.

Communications between the sender computing device and the remote resource transfer computing system can be conducted using a web browser or an application installed on the sender computing device, and may employ various cryptographic communication protocols for security purposes. When present, the application may include instructions that are executable by a processor of the sender computing device to cause the processor to perform operations, including the various resource transfer operations as described in the present disclosure. The web browser or the application may present a number of different user interfaces on the sender computing device. For example, a (e.g., first) user interface may allow a sender to designate a resource to be transferred and a group of recipients (i.e., a “recipient group”) to receive the resource.

In some examples, the first user interface or another user interface of the sender computing device may also be caused to further present one or more selectable additional recipients whom the sender may wish to append to the designated recipient group. In some examples the one or more selectable additional recipients may be determined by a trained machine learning model. In some examples, the sender can select an additional recipient of the one or more selectable additional recipients to receive the designated resource transfer along with recipients of the recipient group. In some examples, the recipients of the recipient group and the one or more selectable additional recipients may be stored in a searchable local directory containing recipient identifying information.

Subsequent to receiving the designation of the resource and the recipient group at the user interface, a resource transfer command message can be transmitted to the resource transfer computing system by the sender computing device. The resource transfer command message may include various resource transfer information. For example, the resource transfer command message can include information that at least identifies a type of the resource to be transferred, and the recipient group to which the resource is to be transferred. In some examples, the information may also specify a value of the resource to be transferred. Other information may also be included. In some examples, the resource transfer command message may be generated by an application executing on the sender computing device.

In some examples, the resource transfer command message can also include various instructions. For example, the resource transfer command message may include instructions that can configure the resource transfer computing system to perform different operations upon receipt of the instructions by the resource transfer computing system. In some examples, the resource transfer computing system may be configured by the instructions to retrieve a set of stored resource transfer rules that are associated with the recipient group.

The process of transferring resources to a group of recipients using modes of transfer selected by the individual recipients in the group assumes a degree of prior registration with the resource transfer computing system. For example, the resource transfer rules may have been previously generated by registering the recipient group with the resource transfer computing system and identifying the different individual members (recipients) in the recipient group. Likewise, the individual recipients in the recipient group can also have registered with the resource transfer computing system and selected (i.e., preselected) one or more modes of transfer to be used for subsequent resource transfers to the recipients. The selected modes of transfer may be saved with the other information as part of the resource transfer rules.

In some examples, when a recipient initially registers a recipient computing device with the resource transfer computing system, the system may automatically direct the recipient to a resource transfer user interface where the recipient can select preferred modes of transfer for future transfer of different types of resources to the recipient. Alternatively, the recipient may, after initially registering the recipient computing device with the resource transfer computing system, navigate to the resource transfer user interface and subsequently select one or more preferred modes of transfer. In some examples, one or more additional resource transfer user interfaces may cooperate with an initial resource transfer user interface to allow a recipient to select secondary (backup) modes of transfer for various types of resources that may be transferred to the recipient.

In some examples, the resource transfer command message may further include instructions that can configure the resource transfer computing system to, after retrieving the resource transfer rules, transfer the resource to each recipient of the recipient group. The resource may be transferred to each recipient of the recipient group according to the resource transfer rules (e.g., according to the preselected modes of transfer identified in the resource transfer rules) and the resource transfer information in the resource transfer command message. When a resource is transferred by the resource transfer computing system, the resource transfer computing system may send a notification of the transfer to the recipient. In some examples, the notification may be a device-specific push notification.

Use of a system according to the disclosure can conserve both computing and human resources. For example, allowing a sender to select different recipient groups that are each prepopulated with a unique collection of multiple recipients (e.g., from a recipient group directory) obviates the need for the user to populate a group with recipients and associated recipient information prior to transferring a resource thereto. Group resource transfer is also far faster and more efficient than independently transferring a resource to each recipient of the recipient group. Likewise, allowing recipients to preselect modes of transfer via which to receive resource transfers and storing that information in a set of resource transfer rules that can be retrieved and followed when performing a group resource transfer eliminates the need for the resource transfer computing system to contact each recipient of a designated recipient group to request a preferred mode of transfer prior to transferring a resource. Systems according to the disclosure can also be implemented and operated using minimal recipient personal information. For example, in addition to a recipient name, only a recipient phone number or email address may additionally be required in order to transfer the resource to the recipient.

These illustrative examples are provided to introduce the reader to the general subject matter discussed herein, and are not intended to limit the scope of the disclosed concepts. In the following description, various additional features and examples are described with reference to the drawings in which like numerals indicate like elements. Various implementations may be practiced without these specific details, and features can be combined together. The figures and description are not intended to be restrictive.

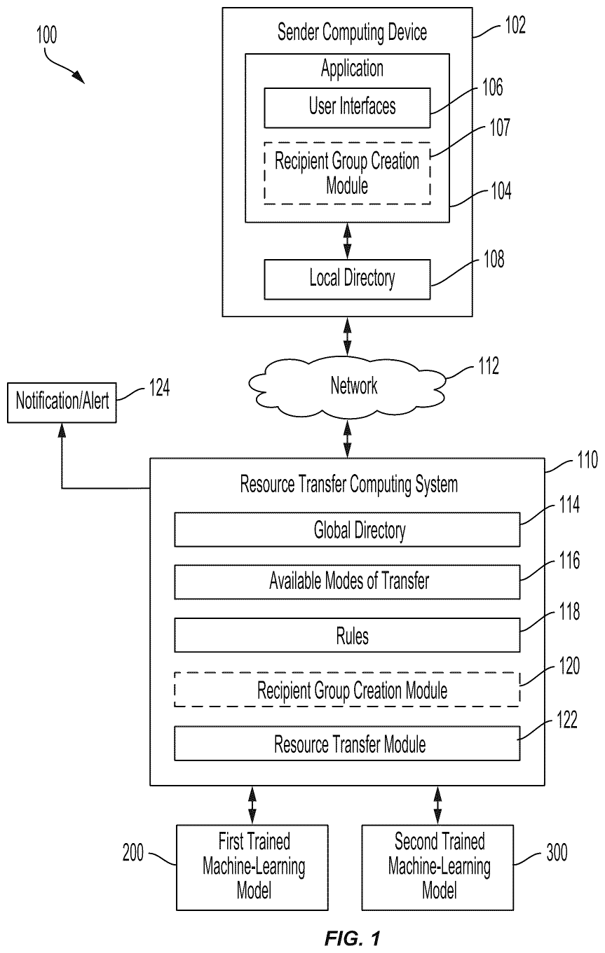

FIG. 1 is a block diagram illustrating one example of a system 100 for facilitating resource transfers to groups of recipients (“recipient groups”) via modes of transfer preselected by the individual recipients of the recipient groups. Thus, while a resource transfer may be made on a group level, the mode of resource transfer to the recipients of the group may be selected on an individual recipient level.

The system 100 is shown, in this example, to include a sender computing device 102. The sender computing device 102 can be, for example, a personal computer, a laptop computer, a tablet, a smart phone, etc. Thus, the sender computing device 102 may include a processor and a memory. A resource transfer application (“application”) 104 may be installed on the sender computing device 102, such as in the memory. The application 104 may include instructions that are executable by the processor to cause the processor to perform operations, including resource transfer operations.

When executed, the application 104 may present one or more user interfaces 106 on the sender computing device 102. For example, a user interface of the one or more user interfaces 106 may allow a sender to designate a resource to be transferred (“resource”) and a recipient group to receive the resource. In some examples, the recipient group may have been previously created by the sender using the sender computing device 102. For example, a recipient group user interface of the one or more user interfaces 106 may facilitate communication between the sender and a recipient group creation module 107 of the sender computing device 102. The recipient group creation module 107 may be programming in the memory of the sender computing device 102, an application that executes on the sender computing device 102, or a separate hardware component that is communicatively coupled to the sender computing device 102.

In some examples, a recipient group may be created by, for example, inputting into the recipient group creation module 107, identifying information for the recipient group and for each of the individual recipients in the recipient group. Identifying information for the recipient group may include, for example, a group name, a group description (e.g., category, class, subclass), etc. In some examples, identifying information for the individual recipients in the group may be entered manually, or individual recipients with prepopulated identifying information may be selected from an existing directory of recipient information (e.g., a sports team roster, a juror list). In another example, the recipient group may instead have been previously created by a resource transfer computing system 110 to which the sender computing device 102 can be communicatively coupled, such as by the sender providing the resource transfer computing system 110 with the same or similar identifying information for the recipient group and the individual recipients in the recipient group. In some examples, recipient groups created by the sender computing device 102 and/or by the resource transfer computing system 110 may be stored in a searchable local directory 108 on the sender computing device 102. The local directory 108 may, at least in some examples, store only minimal recipient personal information (e.g., name, email, phone number).

In some examples, the one or more user interfaces 106 may include portals to other user interfaces. For example, a given one of the user interfaces may accept (e.g., via a search box) identifying information for a recipient group to which the resource is to be transferred. Once the sender has specified an intended recipient group for the resource, one or more additional user interfaces may be presented to allow the sender to undertake other functions. For example, a second user interface may allow the sender to confirm and/or edit the individual recipients of the designated recipient group if such a function was not possible on a prior user interface. It may also be possible via a second or subsequent user interface to cancel the recipient group selection. Sufficient information may be provided to the sender to allow the sender to verify the identities of the individual recipients in the recipient group. For example, an email address or telephone number may be presented along with the name of each recipient.

In some examples, a sender may be presented with one or more selectable additional recipients to whom the sender may also be interested in transferring the resource. In some examples, selected ones of the additional recipients can be temporarily or permanently appended to an already existing recipient group. The one or more selectable additional recipients presented to the sender may be selected, for example, based on past resource transfer activities of the sender, a relationship between the sender and the selectable additional recipients, a relationship between the selectable additional recipients, a category or classification of the recipient group, or otherwise. As described in more detail below, in some examples the one or more selectable additional recipients may be determined by a trained machine learning model. In any case, the sender can select one or more of the additional recipients to each receive the group resource transfer specified on the first user interface. In some examples, the one or more selectable additional recipients may be stored in the searchable local directory 108 along with other recipient information.

As shown, the sender computing device 102 may communicate with the resource transfer computing system 110 over a network 112. The network 112 may be a local area network (LAN), a wide-area network (WAN) such as the Internet, an institutional network, cellular or other wireless networks, and so on.

In some examples, the resource transfer computing system 110 may be operated by the owner of the resource transfer computing system 110, or on behalf of the owner of the resource transfer computing system 110. The resource transfer computing system 110 can include various processing and other hardware and software or application components. For example, the resource transfer computing system 110 may be a server, or a distributed computing system having multiple servers, virtual machines, etc. In other examples, the resource transfer computing system 110 may be a computing system of an entity such as a cloud service provider that facilitates transfer of computing resources such as processing and storage resources to users or a financial institution that facilitates transfer of resources such a monetary payments to recipients. In some examples, the resource transfer computing system 110 may be communicatively coupled to one or more remote servers or other remote computing systems, and may utilize the one or more remote servers or other remote computing systems to transfer resources to recipients at least with respect to certain modes of transfer (e.g., a stored value card mode of transfer).

The resource transfer computing system 110 may include a global directory 114 including at least a plurality of selectable recipient groups. The global directory 114 may be populated in a number of ways. For example, at least a portion of the recipient groups in the global directory 114 may have been created by the sender using the sender computing device, as described above, and then transmitted to the resource transfer computing system 110 and stored in the global directory. In such a case, the global directory 114 may store selectable recipient groups created by multiple senders. Additionally, or alternatively, at least a portion of the recipient groups in the global directory 114 may have been created by the resource transfer computing system 110. The resource transfer computing system 110 can cross-check recipient groups identified by senders via the application 104 with the global directory 114 at least with respect to determining what modes of resource transfer can be used to transfer a resource to the recipients within a given recipient group. For example, when the owner of the resource transfer computing system 110 is a financial institution, the cross-check operation may determine that one or more recipients of a given recipient group has an account with the financial institution to which a monetary resource can be transferred.

The local directory 108 associated with the sender computing device 102 may be populated in part by the global directory 114, and vice versa. For example, when a sender enters recipient group information into the application 104 on the sender computing device 102 that is not present in the global directory 114, the recipient group information may be provided to the resource transfer computing system 110 and subsequently added to the global directory 114. Likewise, the global directory 114 may periodically push, or the application 104 on the sender computing device 102 may periodically request, recipient group information updates from the global directory 114. For example, the global directory 114 may populate the local directory 108 with information for recipient groups that are determined to have an association with a given sender. In some examples, the application 104 on the sender computing device 102 may allow a user to block or otherwise opt out of such information transfers with the global directory 114 of the resource transfer computing system 110. As with the local directory 108 associated with the application 104, the global directory may, at least in some examples, store only minimal personal information (e.g., name, email, phone number) of the individual recipients in the recipient group.

The resource transfer computing system 110 may include available modes of transfer information 116. Particularly, the resource transfer computing system 110 may be aware of the various modes by which it is able to transfer resources to recipient groups and to individual recipients in the recipient groups.

The resource transfer computing system 110 may further include stored sets of rules 118 that can be used to guide resource transfers to recipient groups. For example, a given set of the resource transfer rules 118 may include one or more preselected modes of resource transfer for each individual recipient of a plurality of recipients in a given recipient group. The resource transfer rules 118 may also include information for determining what modes of transfer of all the available modes of transfer will be made available for a particular resource type or for a particular resource value. For example, certain modes of transfer may not be usable to transfer resources having a value that exceeds some predetermined limit, which may be different across different modes of transfer. The resource transfer computing system 110 can also use the rules 118 in conjunction with recipient group recipient information received from the application 104 of the sender computing device 102 or retrieved from the global directory 114. As described in more detail below, the resource transfer computing system 110 may use the rules 118 to determine what modes of transfer may be presented for preselection to a recipient of a particular recipient group and for a particular resource type.

The resource transfer computing system 110 may further include a recipient group creation module 120 which, similarly to the recipient group creation module 107 of the sender computing device 102, can be used to create and populate recipient groups. For example, the recipient group creation module 120 of the resource transfer computing system 110 may receive identifying and other information associated with recipient groups and individual recipients of recipient groups from the sender computing device 102 (e.g., as a result of a sender or other input to the sender computing device 102). The recipient group creation module 120 of the resource transfer computing system 110 may be programming in a memory of the resource transfer computing system 110, an application that executes on the resource transfer computing system 110, or a separate hardware component that is communicatively coupled to the resource transfer computing system 110. Recipient groups created by the resource transfer computing system 110 may be stored in the global directory 114 and, in some examples, may also be exported to the local directory 108 of the sender computing device 102 for additional storage.

Once the sender computing device 102 has received from the sender, a designation of a resource for transfer and a recipient group to receive the resource, the sender computing device 102 can send a resource transfer command message to the resource transfer computing system 110. In some examples, the resource transfer command message may be generated by the application 104. The resource transfer command message can include, as at least part of a payload thereof, instructions for configuring the resource transfer computing system 110 to perform various operations. In some examples, the information can identify at least a type and a value of the resource, and the recipient group that is to receive a transfer of the resource.

Upon receiving the resource transfer command message, the resource transfer computing system 110 may thereby be configured to retrieve the set of the resource transfer rules 118 that are associated with the designated recipient group. The resource transfer computing system 110 may also, based on receipt of the resource transfer command message, initiate a transfer the resource to each recipient of the recipient group according to the set of resource transfer rules 118 and the resource transfer information in the resource transfer command message.

In some examples, the resource transfer computing system 110 may directly transfer the resource to the recipients in the recipient group. For example, when the resource transfer computing system 110 is owned by or operated on behalf of a financial institution, the resource transfer computing system 110 may transfer monetary resources directly to recipients via checks, account deposits, etc. Alternatively, the resource transfer computing system 110 may indirectly transfer the resource to the recipient(s), such as by engaging third party resource transfer systems. In either case, the resource transfer computing system 110 can initiate a resource transfer using a resource transfer module 122. The resource transfer module 122 may be programming in a memory of the resource transfer computing system 110, an application that executes on the resource transfer computing system 110, or a separate hardware component that is communicatively coupled to the resource transfer computing system 110. When a resource transfer is to be made by a third party resource transfer system, the resource transfer module 122 may be (at least temporarily) communicatively coupled to third party resource transfer system to provide resource transfer instructions thereto. The resource transfer module 122 can be configured by instructions in the resource transfer command message to initiate a resource transfer to the recipients in a given recipient group according to the set of resource transfer rules 118.

When a resource is transferred by the resource transfer computing system 110, the resource transfer computing system 110 may send a notification/alert 124 of the transfer to the recipient. In some examples, the notification/alert 124 may be a device-specific push notification, such as a push notification to a mobile computing device such as a smart phone (e.g., as APNS for an iOS operating system or FCM for an Android operating system). In some embodiments, in-app notifications may be sent and may appear as popups on a user interface of the sender computing device 102. In some embodiments, notification messages may be displayed as overlays. The resource transfer computing system 110 may also take other actions related to the transfer of a resource. For example, the resource transfer computing system 110 may receive a confirmation of completion of a resource transfer, such as from a third party resource transfer system or from a sender or recipient computing device. In some examples, the resource transfer computing system 110 may also include a troubleshooting module or other troubleshooting functionality that can implement troubleshooting operations/techniques when a problem is detected with respect to a given resource transfer (e.g., a resource transfer does not initiate or does not complete).

As shown in FIG. 1, the resource transfer computing system 110 may include or may be associated with one or more trained machine-learning models. In this particular example, the resource transfer computing system 110 includes or is associated with two trained machine-learning models 200, 300. For example, a first trained machine-learning model 200 may be used to determine a group of selectable additional recipients to present to a sender for possible transfer of a resource and/or appending to a designated recipient group, and the second trained machine-learning model 300 may be used to determine by what modes of transfer a recipient will most likely prefer to receive a resource.

The first trained machine-learning model 200 may determine one or more selectable additional recipients to present to a given sender, such as via a user interface rendered by the application 104 installed on the sender computing device 102. The first trained machine-learning model 200 used may be unique to a given sender. Thus, the resource transfer computing system 110 may include or may be associated with a plurality of first trained machine-learning models trained to determine selectable recipients to present to corresponding senders of a plurality of senders that are registered with or otherwise authorized to use the resource transfer computing system 110. In such a case, each first trained machine-learning model 200 may be associated with a unique sender of the plurality of senders.

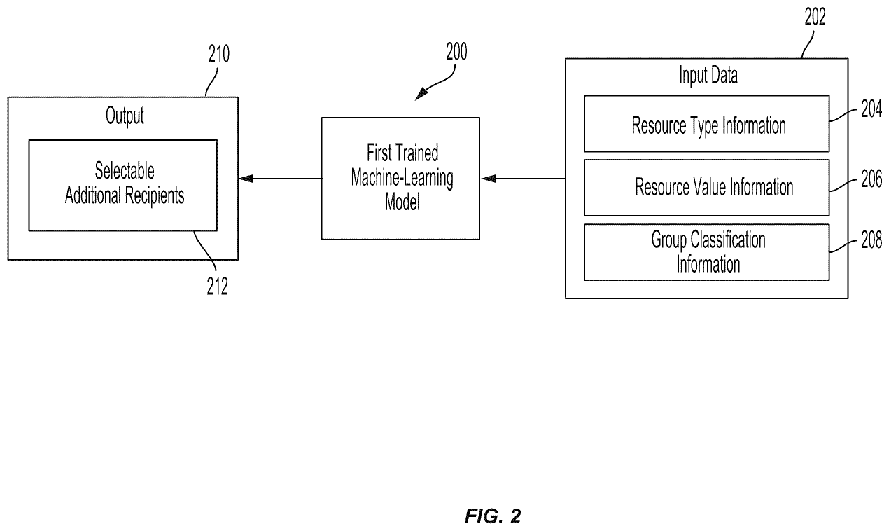

As represented in the block diagram of FIG. 2, the first trained machine-learning model 200 can be provided with input data 202. In this example, the input data 202 may include resource type information 204 and resource value information 206 associated with a resource to be transferred to the recipients of a recipient group. The input data 202 may also include recipient classification information 208, which may be or may include a recipient group category. Recipient group categories may include, for example, “government,” “education,” “housing,” and the like. In at least some examples, the recipient group classification information 208 may also include additional information such as, for example, class and/or subclass information that can further describe and define a given recipient group. For example, a recipient group in the aforementioned “government” category may also be in a “jurors” class (e.g., associated with a group of jurors who are owed payment for jury duty) and possibly a subclass defined by an identification of a courthouse where the group recipients performed jury duty. In another example, a recipient group in the aforementioned “education” category may also be in a “student-athlete” class (e.g., associated with a group of university athletes who are owed per diem compensation for travel) and possibly a subclass defined by an identification of the school (e.g., university) that the group recipients attend. In another example, a recipient group in the aforementioned “housing” category may also be in a “tenants” class (e.g., associated with a group of apartment building tenants who are owed a refund of a deposit) and possibly a subclass defined by an identification of the apartment building in which the tenants reside.

The recipient classification information 208 can be used by the first trained machine-learning model 200 either alone, or in cooperation with the resource type information 204 and/or the resource value information 206 to determine one or more selectable additional recipients to present to the sender as possible additional recipients of the resource. For example, in the former case, if a sender instructs transfer of a resource to a recipient group having a “student-athlete” class and a University X subclass, the output 210 of the first trained machine-learning model 200 may be a determination that one or more recipients from a recipient group having a “student-band” class and the University X subclass should be presented to the sender as a possible additional recipient(s) of the resource, as band members and athletes from the same university often travel to sporting events together and thus the band members from University X may also require per diem travel compensation.

The determination by the first trained machine-learning model 200 of one or more selectable additional recipients to present to the sender as possible additional recipients of the resource may additionally be based on the type of the resource and/or the value of the resource to be transferred. For example, recipients from some recipient groups may be excluded from presentation as possible additional recipients of a resource because the recipient groups have restrictions that prohibit the recipients thereof to receive certain resource types and/or resource transfers above a predetermined value. The first trained machine-learning model 200 may also recognize patterns or trends in recipient groups that receive resource transfers of a particular type and/or of a particular value from a given sender.

In some examples, the first trained machine-learning model 200 can be trained to generate an output 210 based on input of some or all of the input data 202 to the first trained machine-learning model 200. In some examples, only the resource type information 204 and the recipient classification information 208 may be input to the first trained machine-learning model 200. In some examples, only the resource value information 206 and the recipient classification information 208 may be input to the first trained machine-learning model 200. In other examples, all of the resource type information 204, the resource value information 206, and the recipient classification information 208, may be input to the first trained machine-learning model 200. In still other examples, only the recipient classification information 208 may be input to the first trained machine-learning model 200. Various restrictions may be placed on the output 210 of the first trained machine-learning model 200. For example, the output 210 of the first trained machine-learning model 200 may be restricted to limit the number of selectable additional recipients to some predetermined number of recipients and/or to further limit the selectable additional recipients to only those recipients additionally having a particular relationship to the sender or to an already designated recipient group.

In some examples, the first trained machine-learning model 200 may rank or otherwise assign weight to an identified collection of possible selectable additional recipients for presentation to the sender. The ranking or weighting may be used by the resource transfer computing system 110 to determine which of the selectable additional recipients should be presented to a sender in cases where not all selectable additional recipients of an identified collection of possible selectable additional recipients are presented to the sender.

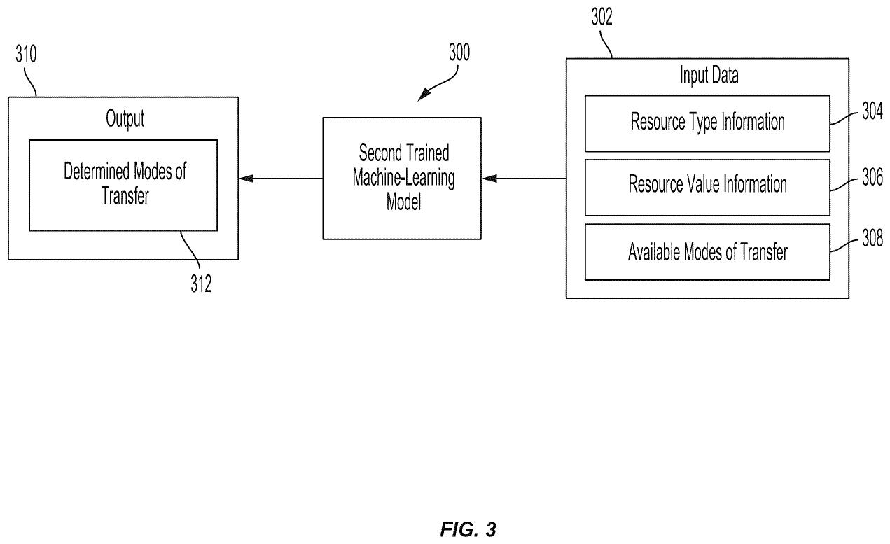

As represented in the block diagram of FIG. 3, the second trained machine-learning model 300 can also be provided with input data 302. In this example, the input data 302 may include resource type information 304 and resource value information 306 associated with a resource to be transferred to a recipient. The input data 302 may also include an identification of all the modes of transfer 308 that can be provided by the resource transfer computing system 110. The second trained machine-learning model 300 can be trained to generate an output 310 based on input of some or all of the input data 302 to the second trained machine-learning model 300. In some examples, only the resource type information 304 and the available modes of transfer 308 may be input to the second trained machine-learning model 300. In some examples, only the resource value information 306 and the available modes of transfer 308 may be input to the second trained machine-learning model 300. In other examples, different combinations of the resource type information 304, the resource value information 306, and the available modes of transfer 308, may be input to the second trained machine-learning model 300.

The output 310 of the second trained machine-learning model 300 may be a determination 312 of one or more of the available modes of transfer of the resource transfer computing system 110 that will be preferred by a recipient of a given recipient group for transfer of a resource. In some examples, the determination 312 may be based only on the type of the resource and the available modes of transfer of the resource transfer computing system 110. In some examples, the determination 312 may be based only on the value of the resource and the available modes of transfer of the resource transfer computing system 110. In other examples, the determination 312 may be based on a combination of one or both of the type of the resource and the value of the resource, in conjunction with the available modes of transfer. Various restrictions may be placed on the output 310 of the second trained machine-learning model 300. For example, the output 310 of the second trained machine-learning model 300 may be restricted to limit the determined modes of transfer preferred by the recipient to some predetermined number of the available modes of transfer.

In some examples, the second trained machine-learning model 300 may rank or otherwise assign weight to the determined modes of transfer that will be preferred by the recipient. The ranking or weighting may be used by the resource transfer computing system 110 to determine which of the determined modes of transfer should be presented to the recipient in cases where all of the determined modes of transfer are not presented to the recipient.

In some examples, the resource transfer computing system 110 can provide a recipient with an alert/notification 124 when a resource type for which the recipient has not previously selected a primary or backup mode of transfer. The recipient may concurrently be asked or permitted to select a primary and backup mode of transfer for the given resource type. In another example, the resource transfer computing system 110 can provide a recipient with the alert/notification 124 when a new mode of transfer is available for one or more resource types. The recipient may then be asked or permitted to select the new mode of transfer as the primary or backup mode of transfer for one or more resource types. In some examples, the new mode of transfer may replace a previously selected mode of transfer for a given resource. In another example, the resource transfer computing system 110 can provide a recipient with the alert/notification when a transfer has been initiated or completed, or if an attempted transfer using a primary or backup mode of transfer preselected by the recipient has failed for any reason.

Model-training applications can be implemented to train machine-learning models to generate the first trained machine-learning model 200 and the second trained machine-learning model 300. The model-training applications may be a part of the resource transfer computing system 110, or the model-training applications may be separate and remote from the resource transfer computing system 110. Training the machine-learning models can transform the machine-learning models from an untrained state to a trained state (i.e., to the first and second trained machine-learning models 200, 300).

Various techniques may be utilized to train the machine-learning models. For example, training data may be provided to the machine-learning models in an iterative manner to enable the machine-learning models to identify trends or relationships in the training data. The machine-learning model training may be supervised training, unsupervised training, or a semi-supervised training. Parameter or hyperparameter adjustment may also be utilized to minimize a loss function of the machine-learning models.

Training the machine-learning models can include accessing the training data, which may be stored, for example, at the resource transfer computing system 110 or at a database or another storage location that is remote from but accessible by the resource transfer computing system 110.

In some examples, the training data associated with training the first trained machine-learning model 200 may include historical sender selection data associated with a plurality of historical resource transfer additional recipient selections, and one or both of resource type data and value data that relates a value to each of the resources associated with the historical sender selection data, and one or both of resource type data and value data that relates a value to each of the resources associated with the historical sender selection data. In some examples, the training data associated with training the second trained machine-learning model 300 may include historical designation data associated with a plurality of historical resource mode of transfer selections made by past recipients. The historical designation data may include, among other information, an identification of the type of each resource represented in the historical designation data. The training data can also include value data that relates a value with each of the resources represented in the historical designation data. The values provided in the value data may be monetary values or values of another nature, depending on the resource type.

In some examples, each of the historical designation data and the value data may be individually used to train the second machine-learning model to generate the second trained machine-learning model 300 that can determine one or more modes of resource transfer preferred by a given recipient. In such a case, the resulting second trained machine-learning model 300 may be trained to determine one or more modes of resource transfer preferred by a given recipient based only on the information associated with the selected training data. For example, if only the value data is used to train the second machine-learning model, the resulting second trained machine-learning model 300 may determine one or more modes of resource transfer preferred by a given recipient based only on the value of a resource to be transferred to the recipient.

In other examples, different combinations of the historical designation data and the value data may be used to train the second machine-learning model 300. This may enable the resulting second trained machine-learning model 300 to more accurately determine one or more modes of resource transfer preferred by a given recipient, as it is possible that recipient mode of resource transfer preferences may frequently be based on more than one factor. To this end, in some examples, all of the historical designation data and the value data may be used in combination to train the second machine-learning model. In some examples, one or more of the historical designation data the value data may be weighted prior to being provided to the second machine-learning model for training. For example, if it is understood that recipient mode of resource transfer designations are most heavily influenced by the value of the resource, then the value data may be assigned more weight than the historical designation data during training of the second machine-learning model.

It is also possible in some examples to include past recipient demographic data in the training data, and to further use the past recipient demographic data to train the second trained machine learning model 300. For example, the training data may further include demographic data for the past recipients represented in the historical selection data. The demographic data may include, for example, one or more of age, gender, and location (e.g., residence information) of a recipient. The demographic data may also include recipient financial information including but not limited to recipient income and user bank account information. Other recipient information that may be usable to identify trends in recipient mode of transfer preferences may also be included in the demographic data. When provided, the demographic data may be used with different combinations of the historical selection data and the value data to train the second trained machine learning model 300. Training the second machine-learning model 300 in this manner can generate a trained machine-learning model that can output a determination 312 of the recipient preferred modes of resource transfer, whether exclusively or in conjunction with different combinations of the resource type information 304 and resource value information 306. While using demographic information may further enhance the ability of the second trained machine-learning model 300 to accurately determine what modes of resource transfer will be preferred by a given recipient, utilizing the demographic information may require the collection and use of additional personal identifying information (PII) beyond what is otherwise required to execute a resource transfer command (e.g., recipient name and email address or telephone number). Consequently, the use of demographic information as described above is entirely optional.

Various fitting, estimation, or other model-training optimization techniques can be used to ensure that, upon evaluation, the predictive output of the first trained machine-learning model 200 and the second trained machine-learning model 300 is accurate given the input data (i.e., to minimize the loss function). One or both of the resulting first and second trained machine-learning models 200, 300 can then be deployed for application to newly received input data, as described above.

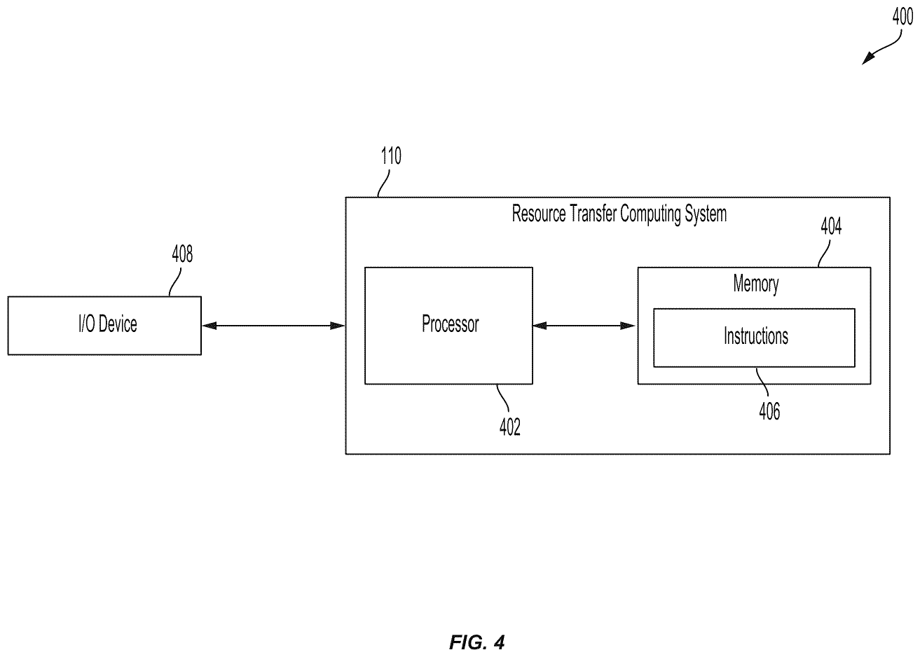

FIG. 4 is a block diagram illustrating various components of a resource transfer computing system, such as the resource transfer computing system 110 of FIG. 1, that is usable to transfer resources to recipient groups via modes of resource transfer selected by the individual recipients of the recipient groups. As illustrated, the resource transfer computing system 110 may include a processor 402. The processor 402 can include one processing device or multiple processing devices. Non-limiting examples of the processor 402 include a Field-Programmable Gate Array (FPGA), an application-specific integrated circuit (ASIC), a microprocessor, etc. A memory 404 may be communicatively coupled to the processor 402. The memory 404 can include instructions that are executable by the processor 402 to cause the processor 402 to perform operations. In some examples, the instructions 406 can include processor-specific instructions generated by a compiler or an interpreter from code written in a suitable computer-programming language, such as C, C++, C #, etc.

The memory 404 can include one memory or multiple memories. The memory 404 can be non-volatile and may include any type of memory that retains stored information when powered off. Non-limiting examples of the memory 404 include electrically erasable and programmable read-only memory (EEPROM), flash memory, or any other type of non-volatile memory. At least some of the memory 404 can be a non-transitory computer-readable medium from which the processor 402 can read the instructions 406. A computer-readable medium can include electronic, optical, magnetic, or other storage devices capable of providing the processor 402 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 402 can read the instructions 406. In some examples, the memory 404 may include the first trained machine-learning model 200 and/or the first trained machine-learning model 200.

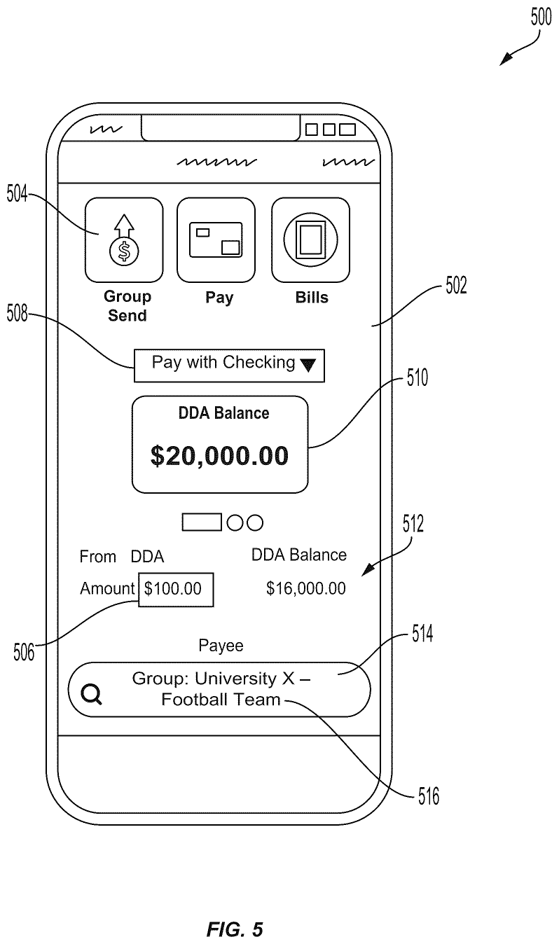

FIG. 5 is a schematic representation of one example of a sender computing device 500 on which is installed a resource transfer application. The sender computing device 500 is communicatively coupled to a resource transfer computing system, such as the resource transfer computing system 110 of FIG. 1. In the example of FIG. 5, the sender computing device 500 is shown to be a smart phone on which is displayed a first resource transfer user interface (“first user interface”) 502. The first user interface 502 may be displayed in response to various actions, such as upon a sender logging in to the resource transfer computing system 110 and the resource transfer computing system 110 subsequently authorizing communications with the sender computing device 500.

As shown, the first user interface 502 may display an interface object such as, for example, a selectable button 504, by which a sender can initiate a group resource transfer process through the resource transfer computing system 110. The first user interface 502 may also display a resource widget 506 (e.g., a typing box or a pull down menu) by which the sender can specify a resource to be transferred. In this example, the resource is specified to be a monetary resource having a value of $100.00. In some examples, such as examples where the resource is a monetary resource, the first user interface 502 may also include a resource location widget 508 by which the sender can specify a location (source) of the resource to be transferred. In this example, the sender has indicated that the $100.00 monetary resource is to be obtained from a checking account of the sender. As shown, an initial account balance 510 of the checking account prior to the resource transfer may also be displayed. When the resource to be transferred is a portion of an overall larger resource, such as a portion of the initial account balance 510, the first user interface 502 may also indicate the portion of the overall larger resource that is still available for transfer 512. For example, in FIG. 5, the indicated balance of $16,000 reflects a $4,000 deduction from the initial $20,000 initial account balance 510 resulting from a $100.00 per diem travel reimbursement to each of 40 football player recipients of a University X football team recipient group.

A shown, the first user interface 502 may also include a portal to a second user interface. For example, the first user interface 502 may include a recipient identification widget 514 (e.g., a search box) where identifying information for a recipient group 516 of the resource may be initially designated. In this example, the sender has designated that the intended recipient group 516 of the resource as “University X Football Team” as the intended recipient group by entering the same into the recipient identification widget 514, such as via typing or a voice utterance. In this example, after the application receives a designation of the intended recipient group 516 of the resource via the recipient identification widget 514, the application may advance to a second user interface. The application may be caused to advance from the first user interface to the second user interface by other mechanisms (e.g., a “next” button) in other examples.

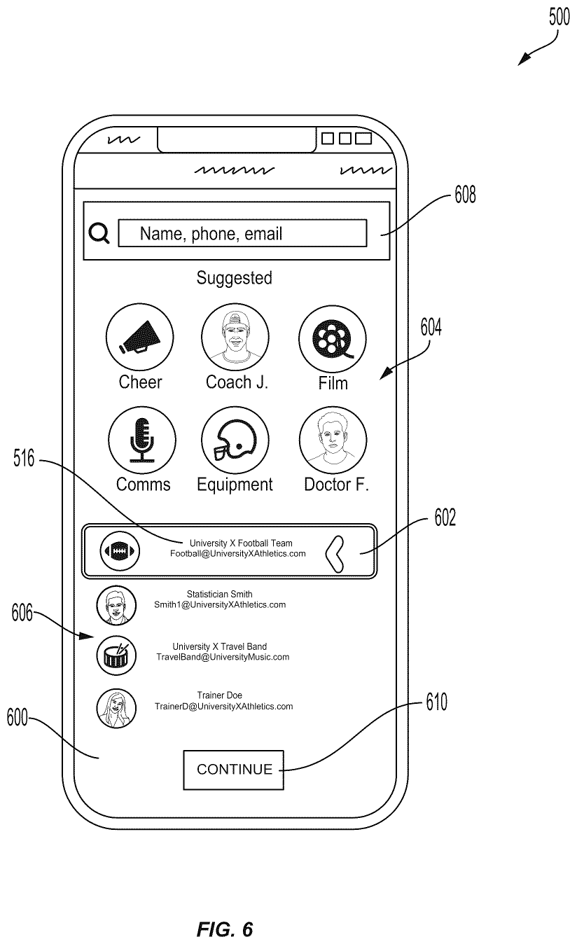

FIG. 6 illustrates one example of a second resource transfer user interface (“second user interface”) 600 that may be rendered by the application on the sender computing device 500. As shown, selection of the “University X Football Team” as the specified recipient group 516 for receiving the resource may be confirmed by the sender on the second user interface 600, such as by way of, for example, a selectable designated recipient group indicator 602. The designated recipient group indicator 602 may, for example, be presented as a popup, an overlay, or another display element in a display area/window of the second user interface 600. As indicated, additional identifying information associated with the specified recipient group 516 may be presented by the designated recipient group indicator 602 on the second user interface 600. For example, a representative email address and/or telephone number may be presented along with the name of the specified recipient group 516 to facilitate verification of the identity of the specified recipient group and to avoid selection and resource transfer to an unintended recipient group.

In some examples, the application may further present on the second user interface 600 one or more selectable additional recipient groups and/or one or more selectable additional recipients to which the sender may also be interested in transferring the resource. A collection 604 of both additional recipient groups and additional individual recipients is shown in FIG. 6. Presented additional individual recipients may or may not be members of one or more other recipient groups. The collection 604 of selectable additional recipient groups and additional individual recipients presented on the second user interface 600 may be selected, for example, based on past resource transfer activities of the sender, a relationship between the designated recipient group (or one or more individual recipients of the recipient group) and the additional recipient groups or additional individual recipients, or a relationship between the additional recipient groups or between the additional individual recipients. As previously described, in some examples, a trained machine-learning model may determine a selectable additional recipient group or one or more selectable additional recipients to present to the sender. In any case, the sender can select one or more of the additional recipient groups or additional recipients to receive the resource transfer specified on the first user interface 502. When one or more additional recipient groups are selected to receive a transfer of the resource, each individual recipient in the recipient group receives the resource. When one or more additional recipient groups or one or more additional individual recipients have been selected to receive a transfer of the resource, the additional recipient groups or additional individual recipients may, in some examples, be displayed along with the designated recipient group 516 in a listing of recipients 606 on the second user interface 600. As with the designated recipient group 516 presented in the designated recipient group indicator 602, each additionally selected recipient group or individual recipient appearing in the listing of recipients 606 may have associated therewith a recipient name and further identifying information such as but not limited to an email address and/or a telephone number. In some examples, the designated recipient group 516 may be highlighted or otherwise emphasized within the listing of recipients 606.

In some examples (as shown), the second user interface 600 may also display a search feature, such as a search box 608, by which the sender can search for other recipient groups or individual recipients for receiving a transfer of the resource. The search box 608 may also allow the sender to search for the actual intended designated recipient group 516 when the additional recipient identifying information presented in designated recipient group indicator 602 indicates that the designated recipient group 516 identified by the application is not the correct recipient (e.g., is the wrong “University X Football Team”). As shown, the search box 608 may allow the sender to search for a recipient using an email address, a phone number, or via identifying information other than or in addition to the recipient's name. A widget or another interface object such as a “continue” button 610 may also be presented on the second user interface 600 to allow the sender to advance the resource transfer process once the sender has specified on the second user interface 600 all the recipients to which the sender desires to transfer the resource.

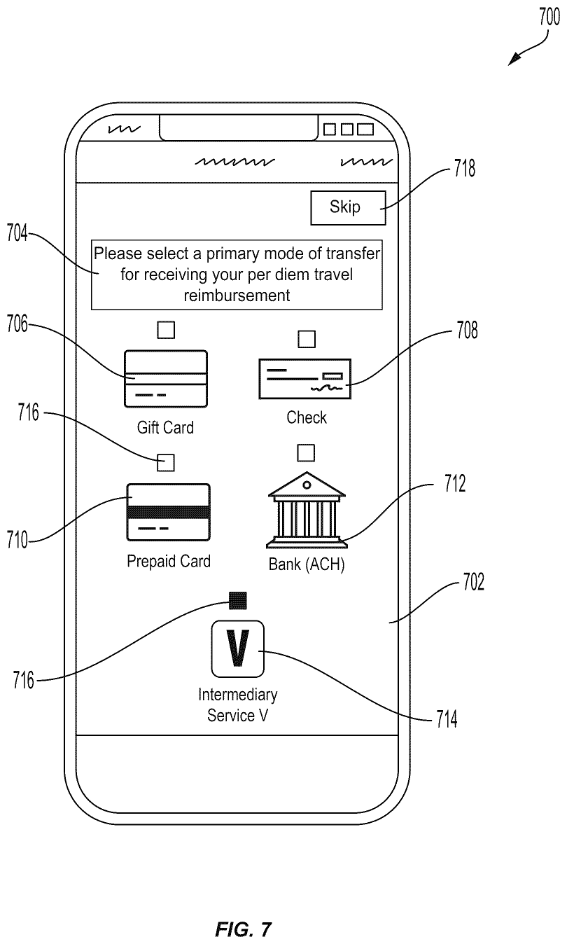

FIG. 7 is a schematic representation of one example of a recipient computing device 700. The recipient computing device 700 is communicatively couplable to a resource transfer computing system, such as the resource transfer computing system 110 of FIG. 1. In the example of FIG. 7, the recipient computing device 700 is shown to be a smart phone on which is displayed a first resource mode of transfer selection user interface (“first user interface”) 702 via which a recipient of a recipient group can select, and register with the resource transfer computing system 110, a preferred primary mode of transfer for receiving one or more types of resources. The first user interface 702 may be displayed in response to various actions, such as upon a recipient logging in to the resource transfer computing system 110 and the resource transfer computing system 110 subsequently authorizing communications with the recipient computing device 700.

As shown, the first user interface 702 may display a notification 704. The appearance and content of the notification 704 may vary. In this particular example, the notification 704 requests that the recipient select a preferred (primary) mode of transfer by which the recipient will automatically receive future transfers of resources in the form of per diem travel reimbursements. A recipient can also or instead select and register preferred modes of transfer for numerous other types of resources in other examples.

A plurality of selectable interface objects 706-714 can also be presented on the first user interface 702. The interface objects 706-714 represent various modes of transfer that are provided by the resource transfer computing system 110 and are selectable for receiving a resource transfer in the form of a per diem travel reimbursement. In this example, the modes of transfer include a gift (stored value) card 706, a paper check 708, a prepaid (e.g., physical or virtual) card 710, a bank (ACH) transfer 712 to a recipient account, a transfer via an intermediary service such as a Venmo® payment 714. Other numbers or types of digital or physical modes of transfer may be presented on the first user interface 702 in other examples.

One or more of the interface objects 706-714 may be selected by any of various techniques. For example, as shown in FIG. 7, a checkbox 716 may be associated with each of the interface objects 706-714 and can be selected via the recipient computing device 700 to indicate that the mode of transfer represented by the associated interface object is the mode of transfer preferred by the recipient for the indicated (per diem travel reimbursement) resource type. In other examples, a presented mode of transfer may be selected by selecting the corresponding interface object 706-714 itself.

As shown an option to skip the process of selecting a preferred (primary) mode of transfer for the per diem travel reimbursement resource type is also presented on the first user interface 702 as an additional selectable “skip” interface object 718. When the skip interface object 718 is selected by the recipient, the modes of transfer selection process can, for example, either move forward to a step of selecting a mode of transfer for another resource type, or can terminate if there is no other resource type for which to select a mode of transfer.

Selecting a checkbox 716 associated with an interface object 706-714 or selecting an interface object itself may be accomplished, for example, by touching the touchscreen of the recipient computing device 700 (smartphone) with a finger of the recipient. When the recipient computing device 700 is for example, a desktop or laptop computer, or another computing device that lacks a touchscreen, selecting a checkbox 716 or an interface object may be accomplished using a keyboard, a mouse, or another input device that is a part of or is communicatively coupled to the recipient computing device 700. In some examples, interface object 706-714 selection may be accomplished by dragging an interface object 706-714 to a designated location on the first user interface 702. The use of other interface object selection techniques is possible in other examples. In some examples, the system may be a virtual reality or augmented reality system, and viewing of and interaction with at least the first user interface 702 and additional resource mode of transfer selection user interfaces may occur in a virtual reality or augmented reality environment. In such a case, the selecting of an interface object 706-714 may be accomplished by hand gestures such as finger pinching, finger dragging, etc.

In the example of FIG. 7, the darkened checkbox 716 indicates that the recipient has selected the intermediary service 714 as the preferred primary mode of transfer for receiving per diem travel reimbursements. As a result, future per diem travel reimbursements payment requests received by the resource transfer computing system 110 and directed to the recipient or a recipient group of which the recipient is a member will automatically be distributed to the recipient via an intermediary service (e.g., Venmo) payment.

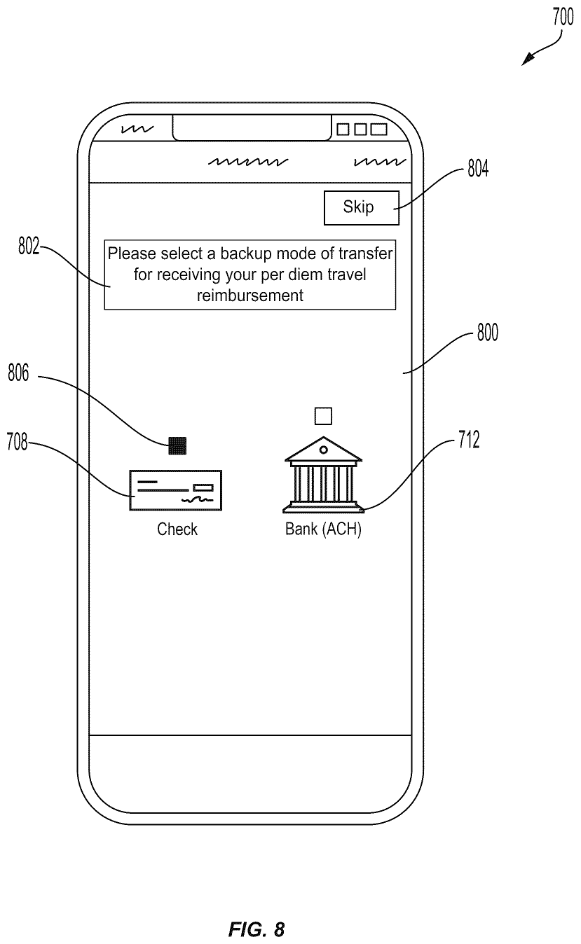

FIG. 8 depicts the recipient computing device 700 of FIG. 7 while displaying a second resource mode of transfer selection user interface (“second user interface”) 802 via which the recipient can select, and register with the resource transfer computing system 110, a preferred secondary (backup) mode of transfer for receiving per diem travel reimbursements. The second user interface 800 may be displayed, for example, after selection of a preferred primary mode of transfer at the first user interface 702. In some examples, the second user interface 800 may be an overlay on the first user interface 702 rather than a separate user interface. The second user interface 800 may be displayed only after selection of one of the presented primary modes of transfer for receiving per diem travel reimbursements represented by the plurality of interface objects 706-714 on the first user interface 702. The second user interface 800 may display a notification 802. The appearance and content of the notification 802 may vary. In this particular example, the notification 802 requests that the recipient select a backup mode of transfer by which the recipient will automatically receive future per diem travel reimbursements if transfer of future per diem travel reimbursements to the recipient is for some reason not possible using the already selected preferred primary mode of transfer.

The second user interface 800 of FIG. 8 can present the recipient with a subset of the plurality of interface objects 706-714 that were not selected as the preferred primary mode of transfer at the first user interface 702. The subset of the plurality of interface objects 706-714 presented on the second user interface 800 is provided to allow the recipient to select the backup mode of transfer if transfer of per diem travel reimbursements by the preferred primary (intermediary service) mode of transfer is not possible. For example, a dollar value transfer limit imposed by the selected intermediary service mode of transfer may prevent a requested per diem travel reimbursement from being transferred to the recipient via the intermediary service. Allowing the recipient to select a backup mode of transfer that can allow for per diem travel reimbursement transfers of higher value can obviate this problem. It may also be possible that the preferred primary mode of transfer (e.g., the intermediary service) is not usable to transfer a per diem travel reimbursement to the recipient for technical or other reasons, and a selected backup mode of transfer can also be used to overcome this problem.

In the example of FIG. 8, the paper check 708 mode of transfer and the bank (ACH) transfer 712 mode of transfer that were not selected by the recipient as the preferred primary mode of transfer for per diem travel reimbursements are presented to the recipient as selectable backup modes of transfer. Other backup modes of transfer and other numbers or combinations of backup modes of transfer may be presented to the recipient in other examples. In this example, the darkened checkbox 806 indicates that the recipient has selected the paper check 708 mode of transfer as the backup mode of transfer for future per diem travel reimbursements.

In some examples, once a backup mode of transfer has been selected by the recipient, the mode of transfer selection process may repeat for a different type of resource. The recipient may be directed to other user interfaces or sets of user interfaces for this purpose. Alternatively, the mode of transfer selection process may terminate if the recipient has already completed the mode of transfer selection process for all resource types distributed by the resource transfer computing system 110, has completed the mode of transfer selection process for all resource types specifically selected by the recipient, or has completed the mode of transfer selection process for all resource types requested by a given sender (such as part of a requested recipient registration process to receive group per diem travel reimbursements).

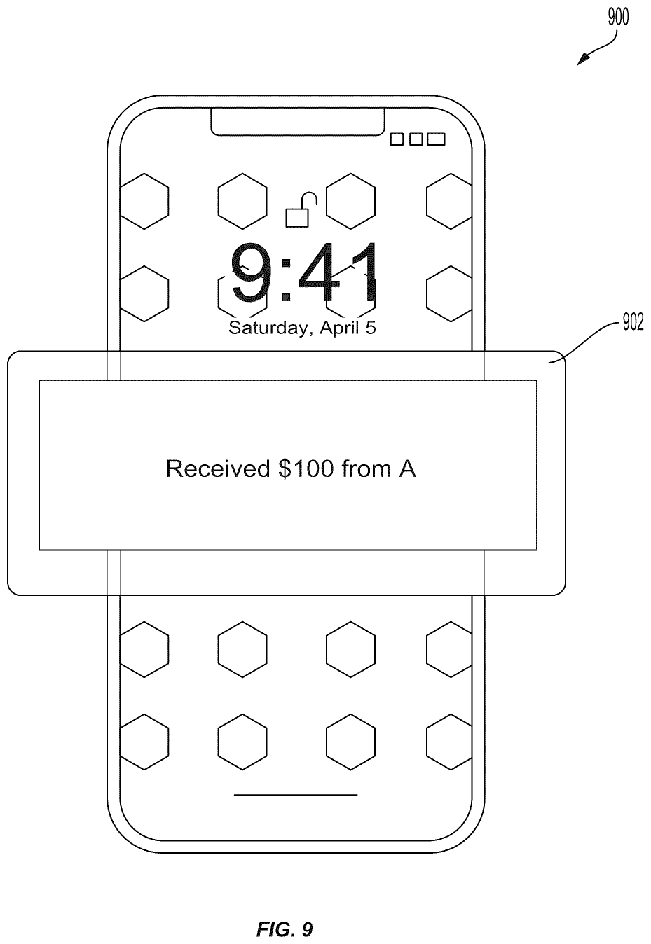

When a resource is transferred to a recipient group by the resource transfer computing system 110, the resource transfer computing system 110 may send a notification of the transfer to each individual recipient in the recipient group. The notification may appear on one or more computing devices of each recipient. One example of a recipient computing device 900 displaying one example of a notification 902 is depicted in FIG. 9. In some examples, the notification 902 may be a device-specific push notification, such as a push notification to a smart phone (e.g., as APNS for an iOS operating system or FCM for an Android operating system). As shown in FIG. 9, in some examples, the notification 902 may be an in-app notification that can be sent to and may appear as a popup on the recipient computing device 900. In some examples, the notification 902 may be displayed on the recipient computing device 900 as an overlay.

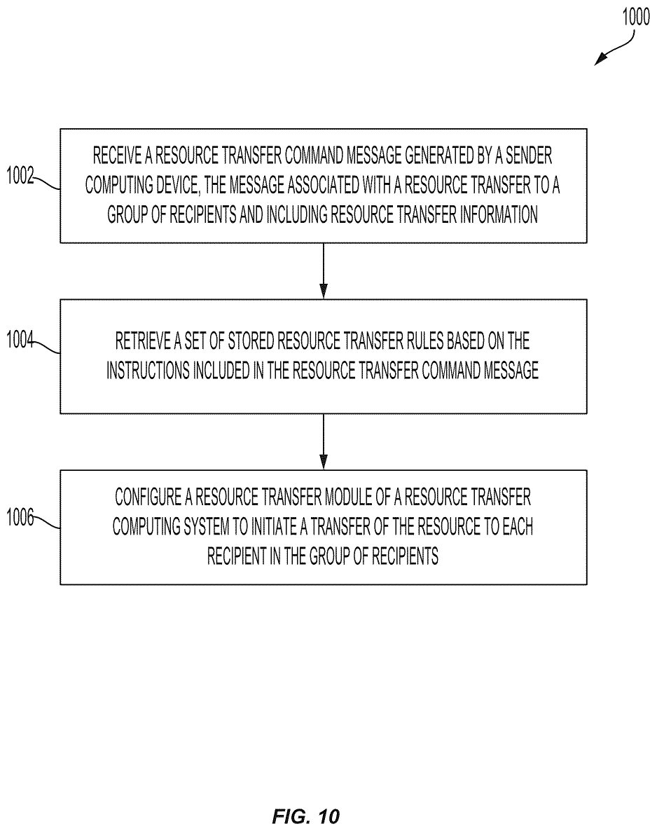

FIG. 10 is a flowchart 1000 of one example of a computer-implemented method for facilitating transfer of a resource to a group of recipients according to resource transfer rules that include recipient-selected modes of transfer. As indicated in block 1002 of the flowchart 1000, a resource transfer command message generated by a sender computing device is received at a resource transfer computing system. In some examples, the resource transfer computing system may be a financial services computing system and the resource may be a monetary sum of a given value. The resource transfer command message is associated with a resource transfer to a group of recipients. The group of recipients may be, for example, a group of jurors who are owed compensation for jury duty or the players on a school sports team that are owed a reimbursement of travel expenses. The resource transfer command message can include various resource transfer information. For example, the resource transfer information can at least identify a resource type, a value of the resource, and the group of recipients to which the resource is to be transferred.

In block 1004 of the flowchart 1000, a set of stored resource transfer rules associated with the recipient group are retrieved based on instructions included in the resource transfer command message. The resource transfer rules can comprise one or more recipient-selected modes of resource transfer for each recipient in the group of recipients. In some examples, recipient-selected modes of resource transfer may be received by sending a task request message to computing devices of the recipients in the recipient group that requests that the recipients select a preferred mode of transfer for at least the resource type to be transferred to the recipient group. The task request message may be sent, for example, at or around a time of recipient group creation such that the recipient-selected modes of resource transfer are known and can be stored as part of the resource transfer rules prior to a time of resource transfer to the recipient group.

Upon receipt of the task request message at a given recipient computing device, the recipient computing device may be caused to display, via a successive series of user interfaces, a plurality of modes of distribution by which various indicated resource types are distributable to the recipient. In some examples, each resource type may be associated with a unique user interface. A selection by the recipient of a preferred mode of distribution for each of the resource types can then be made via the corresponding user interfaces of the recipient computing device. The recipient-selected modes of distribution can then be received by the processor and stored in the resource transfer rules.

At block 1006 of the flowchart 1000, the resource can be transferred to each recipient in the group of recipients according to the resource transfer rules and the resource transfer information in the resource transfer command message. In some examples, the transfer of the resource may be nonuniform in value across the recipients of the group of recipients. That is, some of the recipients in the group of recipients may receive a resource transfer of greater or lesser value than other recipients in the group of recipients. Further, each recipient in the group of recipients can receive the resource transfer via the recipient's individually selected mode of transfer, despite the overall resource transfer being a group resource transfer.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processor; and
a memory communicatively coupled to the processor, the memory including instructions that are executable by the processor to cause the processor to perform operations comprising:
receiving, from a sender computing device over a network, a resource transfer command message, wherein the resource transfer command message is associated with a transfer of a resource to a group of recipients and includes resource transfer information that at least identifies a type of the resource, a value of the resource, and the group of recipients; and
based on instructions included in the resource transfer command message:
retrieving a stored set of resource transfer rules associated with the group of recipients, the set of resource transfer rules comprising, for each recipient in the group of recipients, a recipient-selected primary mode of resource transfer for and a recipient-selected backup mode of resource transfer for at least the type of the resource, wherein the recipient-selected primary mode of resource transfer and the recipient-selected backup mode of resource transfer were previously received from a computing device of the recipient in response to a task request message requesting selection of one or more preferred modes of transfer for at least the type of the resource, and were stored as part of the set of resource transfer rules prior to transfer of the resource to the group of recipients, and
configuring a resource transfer module of the system to initiate a transfer of the resource to each recipient in the group of recipients according to the set of resource transfer rules and the resource transfer information in the resource transfer command message, including automatically initiating transfer of the resource to a given recipient using the recipient-selected primary mode of resource transfer and, if transfer using the recipient-selected primary mode of resource transfer is not possible, automatically initiating transfer of the resource to the given recipient using the recipient-selected backup mode of resource transfer.

2. The system of claim 1, wherein the receiving the resource transfer command message from the sender computing device occurs via communications enabled by a web browser or an application executing on the sender computing device.

3. The system of claim 1, wherein the group of recipients is one group of recipients of a plurality of selectable groups of recipients retrievable from a recipient group directory.

4. The system of claim 1, wherein the instructions of the resource command message mandate a transfer of the resource that is nonuniform in value across the recipients of the group of recipients.

5. The system of claim 1, wherein the set of resource transfer rules include different primary or backup modes of resource transfer for at least some of the recipients in the group of recipients.

6. The system of claim 1, wherein the operations further comprise:
based at least on the group of recipients, transmitting a response message to the sender computing device to cause the sender computing device to present, on a user interface thereof, one or more additional recipients for receiving a transfer of the resource;
receiving, from the sender computing device, a selection of an additional recipient of the one or more additional recipients;
retrieving or obtaining primary and secondary modes of resource transfer for the additional recipient; and
adding the primary and secondary modes of resource transfer for the additional recipient to the set of resource transfer rules associated with the group of recipients.

7. The system of claim 6, wherein the operations further comprise determining the one or more additional recipients for presentation on the sender computing device by:
providing an input to a trained machine-learning model, wherein the input comprises an identification of a classification of the group of recipients and one or both of the resource type and the resource value, and wherein the trained machine-learning model is trained on training data comprising historical sender selection data associated with a plurality of historical resource transfer additional recipient selections, and one or both of resource type data and value data that relates a value to each of the resources associated with the historical sender selection data;
generating as an output, by the trained machine-learning model, an identification of the one or more additional recipients as most likely to be of interest to the sender; and
selecting some or all of the one or more additional recipients output by the trained machine-learning model for presentation on the sender computing device.

8. A computer-implemented method comprising:
receiving, at a resource transfer computing system, from a sender computing device over a network, a resource transfer command message, wherein the resource transfer command message is associated with a transfer of a resource to a group of recipients and includes resource transfer information that at least identifies a type of the resource, a value of the resource, and the group of recipients; and
based on instructions included in the resource transfer command message:
retrieving a stored set of resource transfer rules associated with the group of recipients, the set of resource transfer rules comprising, for each recipient in the group of recipients, a recipient-selected primary mode of resource transfer and a recipient-selected backup mode of resource transfer for at least the type of the resource, wherein the recipient-selected primary mode of resource transfer and the recipient-selected backup mode of resource transfer were previously received from a computing device of the recipient in response to a task request message requesting selection of one or more preferred modes of transfer for at least the type of the resource, and were stored as part of the set of resource transfer rules prior to transfer of the resource to the group of recipients, and
configuring a resource transfer module of the resource transfer computing system to initiate a transfer of the resource to each recipient in the group of recipients according to the set of resource transfer rules and the resource transfer information in the resource transfer command message, including automatically initiating transfer of the resource to a given recipient using the recipient-selected primary mode of resource transfer and, if transfer using the recipient-selected primary mode of resource transfer is not possible, automatically initiating transfer of the resource to the given recipient using the recipient-selected backup mode of resource transfer.

9. The computer-implemented method of claim 8, wherein the value of the resource transferred to the recipients is unequally distributed among the recipients.

10. The computer-implemented method of claim 8, wherein the resource transfer computing system creates groups of recipients using group and recipient identifying information received from the sender computing device.

11. The computer-implemented method of claim 10, wherein groups of recipients created by the resource transfer computing system are stored in a global directory associated with the resource transfer computing system.

12. The computer-implemented method of claim 8, wherein, based on the set of resource transfer rules, the mode of transfer by which the resource is transferred to the group of recipients differs for at least some of the recipients.

13. The computer-implemented method of claim 8, further comprising:
based at least on the group of recipients, transmitting a response message to the sender computing device to cause the sender computing device to present, on a user interface thereof, one or more additional recipients for receiving a transfer of the resource;
receiving, from the sender computing device, a selection of an additional recipient of the one or more additional recipients;
retrieving or obtaining primary and secondary modes of resource transfer for the additional recipient; and
adding the primary and secondary modes of resource transfer for the additional recipient to the set of resource transfer rules associated with the group of recipients.

14. The computer-implemented method of claim 13, further comprising determining the one or more additional recipients for presentation on the sender computing device by:
providing an input to a trained machine-learning model, wherein the input comprises an identification of a classification of the group of recipients and one or both of the resource type and the resource value, and wherein the trained machine-learning model is trained on training data comprising historical sender selection data associated with a plurality of historical resource transfer additional recipient selections, and one or both of resource type data and value data that relates a value to each of the resources associated with the historical sender selection data;
generating as an output, by the trained machine-learning model, an identification of the one or more additional recipients as most likely to be of interest to the sender; and
selecting some or all of the one or more additional recipients output by the trained machine-learning model for presentation on the sender computing device.

15. The computer-implemented method of claim 8, further comprising:
sending to a computing device of each recipient of the group of recipients, a task request message requesting a selection of a mode of resource transfer for at least one new resource type;
in response to sending the task request messages, receiving from the recipient computing devices, the recipient-selected modes of resource transfer for the new resource type; and
updating the set of resource transfer rules associated with the group of recipients by storing therein the one or more recipient-selected modes of resource transfer for the new resource type.

16. A non-transitory computer-readable medium comprising instructions that are executable by a processor for causing the processor to perform operations comprising:
receiving, at a resource transfer computing system, from a sender computing device over a network, a resource transfer command message, wherein the resource transfer command message is associated with a transfer of a resource to a group of recipients and includes resource transfer information that at least identifies a type of the resource, a value of the resource, and the group of recipients; and
based on instructions included in the resource transfer command message:
retrieving a stored set of resource transfer rules associated with the group of recipients, the set of resource transfer rules comprising, for each recipient in the group of recipients, a recipient-selected primary mode of resource transfer and a recipient-selected backup mode of resource transfer for at least the type of the resource, wherein the recipient-selected primary mode of resource transfer and the recipient-selected backup mode of resource transfer were previously received from a computing device of the recipient in response to a task request message requesting selection of one or more preferred modes of transfer for at least the type of the resource, and were stored as part of the set of resource transfer rules prior to transfer of the resource to the group of recipients, and
configuring a resource transfer module of the resource transfer computing system to initiate a transfer of the resource to each recipient in the group of recipients according to the set of resource transfer rules and the resource transfer information in the resource transfer command message, including automatically initiating transfer of the resource to a given recipient using the recipient-selected primary mode of resource transfer and, if transfer using the recipient-selected primary mode of resource transfer is not possible, automatically initiating transfer of the resource to the given recipient using the recipient-selected backup mode of resource transfer.

17. The non-transitory computer-readable medium of claim 16, wherein the set of resource transfer rules include different primary or backup modes of resource transfer for at least some of the recipients in the group of recipients.

18. The non-transitory computer-readable medium of claim 16, wherein the operations further comprise:
based at least on the group of recipients, transmitting a response message to the sender computing device to cause the sender computing device to present, on a user interface thereof, one or more additional recipients for receiving a transfer of the resource;
receiving, from the sender computing device, a selection of an additional recipient of the one or more additional recipients;
retrieving or obtaining primary and secondary modes of resource transfer for the additional recipient; and
adding the primary and secondary modes of resource transfer for the additional recipient to the set of resource transfer rules associated with the group of recipients.

19. The non-transitory computer-readable medium of claim 16, wherein the operations further comprise determining the one or more additional recipients for presentation on the sender computing device by:
providing an input to a trained machine-learning model, wherein the input comprises an identification of a classification of the group of recipients and one or both of the resource type and the resource value, and wherein the trained machine-learning model is trained on training data comprising historical sender selection data associated with a plurality of historical resource transfer additional recipient selections, and one or both of resource type data and value data that relates a value to each of the resources associated with the historical sender selection data;
generating as an output, by the trained machine-learning model, an identification of the one or more additional recipients as most likely to be of interest to the sender; and
selecting some or all of the one or more additional recipients output by the trained machine-learning model for presentation on the sender computing device.

20. The non-transitory computer-readable medium of claim 16, wherein the operations further comprise:
sending to a computing device of each recipient of the group of recipients, a task request message requesting a selection of a mode of resource transfer for at least one new resource type;
receiving from the recipient computing devices, the recipient-selected modes of resource transfer for the new resource type; and
updating the set of resource transfer rules associated with the group of recipients by storing therein the one or more recipient-selected modes of resource transfer for the new resource type.
